(19) United States
(12) Patent Application Publication
(10) Pub. No.: US 2006/0248244 A1
(43) Pub. Date: Nov. 2, 2006

(54) Flash disk with wireless blue tooth function

(76) Inventor: Fan Chia Hua, Taipei (TW)

Correspondence Address: Fan Chia Hua, 235 Chung-Ho, Box 8-24, Taipei, TW

(21) Appl. No.: 11/158,759

(22) Filed: Jun. 23, 2005

(30) Foreign Application Priority Data
Apr. 28, 2005 (TW) 094113600

(51) Int. Cl. G06F 13/38

(52) U.S. Cl. 710/62

(57) ABSTRACT

A flash disk with wireless Blue tooth function comprises a battery capable of storing power for supplying power to other element of the body; a USB port connected with anther USB port of a external device; a control unit for controlling data transmission of the USB port; a blue tooth module being a wireless transmission element; a memory control unit; and a flash memory unit for storing data. The flash disk with wireless blue tooth function having a Flash RAM is a small size one. The device has not only a USB port for data transmission, but also has a blue tooth module so as to have the function of wireless data transmission. Thus, the flash disk is able to transmit data by using a blue tooth module to wirelessly transmitting data from one computer to another computer.

### FIELD OF THE INVENTION

The present invention relates to flash disks, and in particular to a flash disk used in the device with wireless blue tooth function.

### BACKGROUND OF THE INVENTION

Due to technology improvement, computers are more and more important to human life. Almost all of data is stored by electric files regardless of companies application, families or individual applications. In the prior art, 1.44 MB floppy disks are used in transferring electric files from one computer to another computer. However, the small capacity of floppy disks is unable to satisfy the demand of files with larger amount of data. A disk with a large capacity of data, such as MO or ZIP, is not only expensive, but also unavailable to be installed in all devices. As for duplication disks with large capacities, the disks are limited by the installation of duplication devices.

Recently a flash disk with a Flash RAM is fashionable and popular for sale in an electric consumer market. The flash disk is not only small size and portable, but also is usable easily, because USB devices are available currently in various computers and driver programs are not necessary to be installed for various versions of Windows Me. More importantly, the device has the advantage of a large capacity for storing data, which has a range approximately between several decades of MB to several GB.

Referring to FIG. 1, a prior art flash disk comprises a body 10 and a USB port 13. A circuit unit and a flash memory unit are installed in the body 10. A USB port 13 offers the function of transmission between the flash disk 1 and a computer. According to the prior art, the USB port 13 is necessary to be inserted to an USB port of the computer. The present invention provides a more convenient way for the data transmission between the flash disk 1 and the computer.

### SUMMARY OF THE INVENTION

The primary objective of the present invention is to provide a flash disk with wireless blue tooth function so as to increase the convenience of the flash disk. The present invention improves a prior art from a conventional inserting way to a wireless transmission. Other than improving the using convenience of the device, the high-technological device has a popular commercial product.

To achieve above object, the present invention provides a flash disk with wireless Blue tooth function which comprises a battery capable of storing power for supplying power to other element of the body; a USB port for being connected with anther USB port of a external device; a control unit for controlling data transmission of the USB port; a blue tooth module being a wireless transmission element; a memory control unit a flash memory unit being for storing data. The flash disk with wireless blue tooth function having a Flash RAM is a small size one. The device has not only a USB port for data transmission, but also has a blue tooth module so as to have the function of wireless data transmission. Thus, the flash disk is able to transmit data by using a blue tooth module to wirelessly transmitting data from one computer to another computer.

The blue tooth module according to the present invention includes a wireless module and a base band module, which is free from the problem of interference because the modules use a frequency band having a value as high as 2.4 GHz to transfer data and the frequency is a common use in worldwide. Each blue tooth transmission device has a 48-bit address according to the IEEE 802 standard, so that the transferring distance is limited in a range of ten meters. The blue tooth technique is capable of transmitting a large amount of data for 1 MB in every second. Furthermore, transferring data is difficult to be intercepted, because encryption with the frequency variation over 1600 times per minute can be set without any electromagnetic interference.

The present invention offers a convenient function, which the flash disk is not necessary to be inserted into a USB port of a computer.

The various objects and advantages of the present invention will be more readily understood from the following detailed description when read in conjunction with the appended drawing.

### BRIEF DESCRIPTION OF THE DRAWINGS

FIG. 1 is a perspective view of the present invention.

FIG. 2 is a schematic view showing the internal structure of the present invention.

FIG. 3 is a perspective view showing a partial structure of the invention internal a computer.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

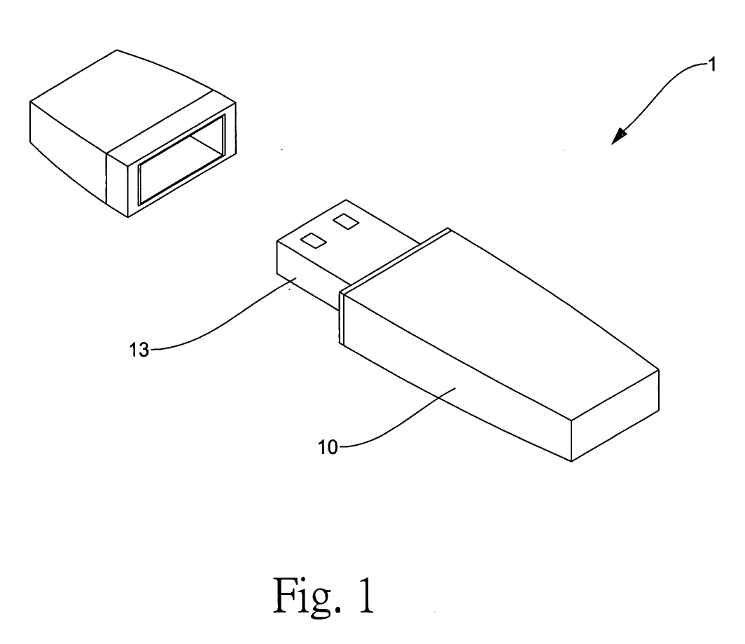

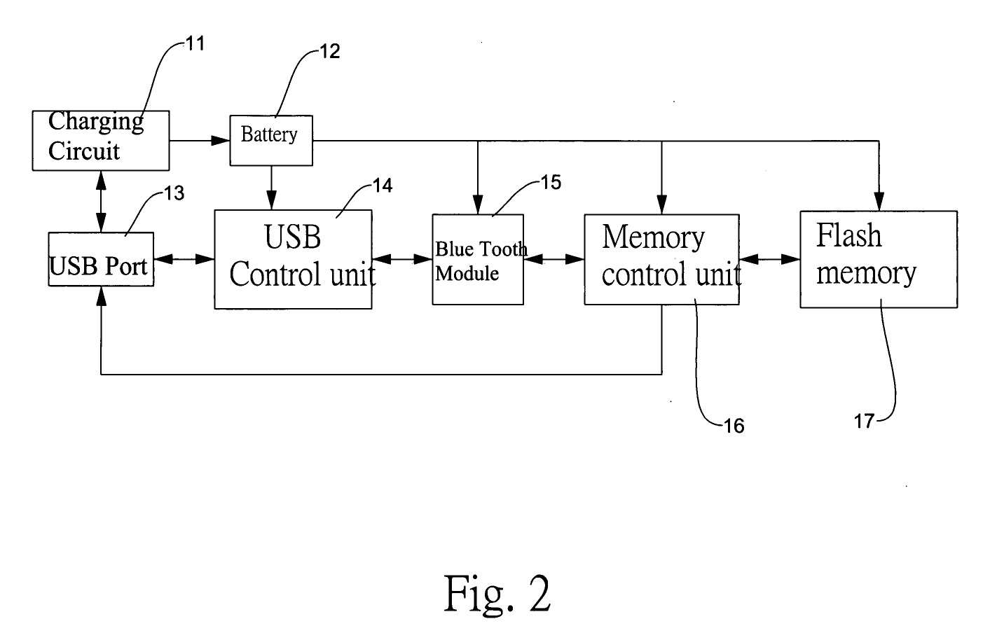

Referring to FIGS. 1 and 2, the flash disk with wireless Blue tooth function of the present invention is illustrated. The flash disk 1 of the present invention includes a body 10 and a USB port 13. The body 10 has the following elements.

A charging circuit 11 receives power through the USB port 13.

A battery 12 capable of storing power receives the power from the charging circuit 11. The battery serves to supply power to other element of the body 10.

A USB port 13 is a prior art transmission structure.

A control unit 14 serves to control data transmission of the USB port 13.

A blue tooth module 15 is a wireless transmission element according to the IEEE 802 standard.

A memory control unit 16 serves for controlling the data transmission of the flash disk 1.

A flash memory unit 17 is a flash RAM for storing data.

The data transmission of the flash disk 1 with a computer will be described herein.

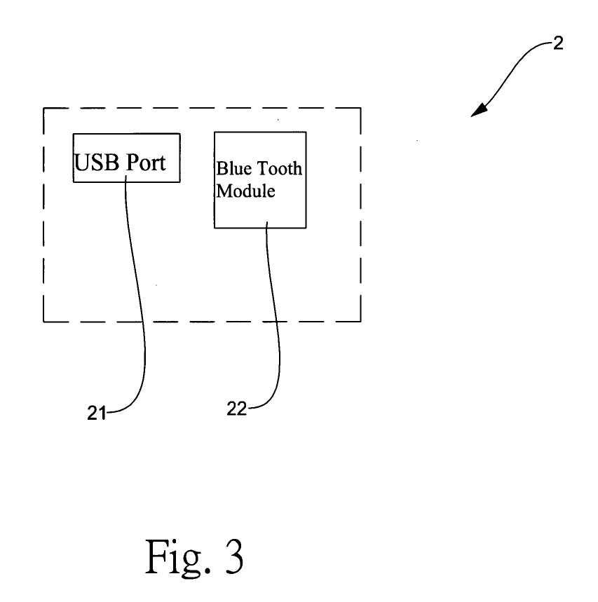

Referring to FIGS. 3, when a computer 2 is built with the blue tooth module 22, by the wireless transmission function of the blue tooth module 22 of the flash disk 1, the data can be transferred between the flash disk 1 and the computer 2.

If the power of the battery 2 of the flash disk 1 is insufficient so that the blue tooth module 15 cannot be used in the wireless transmission, or if the computer 2 is not built with the blue tooth module 22, the USB port 13 of the flash disk 1 can be inserted into the USB port 21 of the computer 2 for data transmission

Thereby, it is known that the flash disk 1 of the present invention is not only used for wireless transmission, but also when the peripherals cannot support the flash disk 1 or the power of the peripherals are also insufficient, then the USB port 13 can still be used in data transmission due to installation of the charging circuit 11.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claim is:

1. A flash disk with wireless Blue tooth function comprising:
a battery capable of storing power for supplying power to other element of the body;
a USB port connected with anther USB port of an external device;
a control unit for controlling data transmission of the USB port;
a blue tooth module being a wireless transmission element;
a memory control unit; and
a flash memory unit for storing data.

2. The flash disk with wireless blue tooth function as claimed in claim 1, further comprising a charging circuit for charging power to the battery.

3. The flash disk with wireless blue tooth function as claimed in claim 2, wherein the charging circuit receives power through the USB port so as to charge the battery.

4. The flash disk with wireless Blue tooth function as claimed in claim 1, wherein the flash memory unit is a flash RAM.
